(19) United States
(12) Patent Application Publication
(10) Pub. No.: US 2017/0316090 A1
(43) Pub. Date: Nov. 2, 2017

(54) TERMINAL, VEHICLE AND CONTROLLING METHOD THEREFOR

(71) Applicants: Hyundai Motor Company, Seoul (KR); Kia Motors Corporation, Seoul (KR)

(72) Inventor: Sooyoung Shin, Seongnam (KR)

(21) Appl. No.: 15/286,179

(22) Filed: Oct. 5, 2016

(30) Foreign Application Priority Data
Apr. 27, 2016 (KR) 10-2016-0051588

(51) Int. Cl. G06F 17/30; G06F 3/16

(52) U.S. Cl. CPC G06F 17/30772; G06F 17/30752; G06F 3/165; G06F 17/3053

(57) ABSTRACT

A vehicle includes: a communication unit enabling communication with an external device; a storage storing a plurality of song information of audio songs stored in the external device; an input unit receiving a play command from the external device; a controller controlling the storage so as to store the plurality of song information and reading out audio data from the external device based on the plurality of song information stored in the storage, upon reception of the play command from the external device; and a sound output unit outputting the audio data read out by the controller. When the play command is received from the external device, the controller controls the storage so as to store a predetermined number of song information among the plurality of song information in a first database of the storage and store the remaining song information of the plurality of song information in a second database of the storage, determines rankings of the song information stored in the first database, and controls the sound output unit so as to output the audio songs sequentially based on a reference ranking.

### CROSS-REFERENCE TO RELATED APPLICATION

This application claims priority to and the benefit of Korean Patent Application No. 10-2016-0051588, filed on Apr. 27, 2016, the disclosure of which is incorporated herein by reference in its entirety.

### BACKGROUND

### 1. Technical Field

The present disclosure relates generally to a terminal, vehicle, and controlling method therefor and, more particularly, to a terminal, vehicle, and controlling method for providing audio content.

### 2. Discussion of Related Art

Current vehicles provide various user-convenient functions, such as audio play, video play, Global Positioning System (GPS) or navigation functions, air conditioning (AC) and ventilation, seat heating, communication with a user equipment (UE), etc. Vehicles may also include a terminal for the vehicle (or vehicle terminal) to manipulate the audio play, video play, GPS functions, etc., and to output operation information in response to the manipulation.

The vehicle terminal and a connected UE include audio play functions to read out and play audio data from various types of storage media, such as optical disks or hard disks. Specifically, the vehicle terminal and the connected UE read out and reproduce audio songs recorded on the optical disk or hard disk by reading out navigation information recorded in a certain area, such as the lead-in area of the optical disk, storing the navigation information in a memory, and reproducing the audio songs on the optical disk by retrieving and referring to the navigation information stored in the memory.

The vehicle terminal and the UE can also store information of audio songs in the memory in a predetermined order and sequentially reproduce them in the order in which they are stored in the memory, or randomly store the information of audio songs recorded on a storage medium in the memory and select and reproduce the audio songs stored in the memory one at a time according to a random function (e.g., in a random play mode). However, the vehicle terminal and the UE can experience problems with selecting and reproducing audio songs stored in the memory according to a random function when attempting to reproduce previous songs. Furthermore, since the vehicle terminal and the UE have to delete all information stored in the memory after the audio songs stored in the memory were all played and, in the random play mode, store information of the audio songs in the memory once again, instantaneous overload may occur, making the player system unstable.

### SUMMARY OF THE DISCLOSURE

The present disclosure provides a terminal, vehicle and controlling method therefor, which enables reproduction of previous or subsequent songs in a random play mode. The present disclosure also provides a terminal, vehicle and controlling method therefor, which eliminates song information in the top ranking of a list in a first database, creates a lowest ranking in the first database, and adds one of a plurality of song information in a second database to the lowest ranking, in response to a command to play a next song in a random play mode.

In accordance with embodiments of the present disclosure, a vehicle includes: a communication unit enabling communication with an external device; a storage storing a plurality of song information of audio songs stored in the external device; an input unit receiving a play command from the external device; a controller controlling the storage so as to store the plurality of song information and reading out audio data from the external device based on the plurality of song information stored in the storage, upon reception of the play command from the external device; and a sound output unit outputting the audio data read out by the controller, wherein, when the play command is received from the external device, the controller controls the storage so as to store a predetermined number of song information among the plurality of song information in a first database of the storage and store the remaining song information of the plurality of song information in a second database of the storage, determines rankings of the song information stored in the first database, and controls the sound output unit so as to output the audio songs sequentially based on a reference ranking.

When the received play command corresponds to a command to perform random play, the controller may control the storage so as to randomly store the predetermined number of song information among the plurality of song information in the first database and randomly store the remaining song information in the second database, delete a predefined number of top ranking song information from the first database, and add a predefined number of song information stored in the second database to a lowest ranking in the first database.

The reference ranking may correspond to any of the rankings of the plurality of song information stored in the first database excluding the highest and the lowest rankings thereof.

The reference ranking may correspond to a middle ranking of the rankings of the song information stored in the first database.

The controller may determine song information in a ranking to be played and read out audio data corresponding to the determined song information from the storage, while playing control is performed.

When the received play command corresponds to a command to perform sequential play, the controller may arrange the song information stored in the first database in a predetermined order corresponding to an order in which the audio songs are stored in the external device.

When a command to play a previous song is received from the external device, the controller may update top ranking song information stored in the first database and delete lowest ranking song information from the first database.

The controller may delete top ranking song information from the first database and add song information stored in the second database to the lowest ranking in the first database.

The second database may store a plurality of song information and rankings that match the plurality of song information, and the controller may sequentially extract the plurality of song information stored in the second database and add song information deleted from the first database to the extracted ranking, when adding song information to the lowest ranking in the first database.

The second database may store a plurality of song information and rankings that match the plurality of song information, and the controller may randomly extract song information stored in the second database and add song information deleted from the first database to the extracted ranking, when adding song information to the lowest ranking in the first database.

Furthermore, in accordance with embodiments of the present disclosure, a vehicle includes: a communication unit enabling communication with an external device; a storage storing a plurality of song information of audio songs stored in the external device; a controller controlling the storage so as to randomly store a predetermined number of song information among the plurality of the song information in a first database of the storage and randomly store the remaining song information of the plurality of song information in a second database of the storage, and reading out audio data from the storage based on the song information stored in the first database, when a command to perform random play is received from the external device; and a sound output unit outputting the audio data read out by the controller. When an audio song different from a currently played audio song is to be played, the controller deletes a predefined number of song information from the first database and adds a predefined number of song information in the second database to the first database.

The first database may store a list of a plurality of song information with matching rankings, the controller may determine song information having higher rankings than song information of the currently played audio song, and when deleting the predefined number of song information from the first database, the controller may select and delete a predetermined number of song information in correspondence with a predetermined number of rankings from currently played song information among the higher ranking song information.

When adding the song information in the second database to the first database, the controller may additionally create a predetermined number of rankings for lowest rankings in the first database and add a predetermined number of song information stored in the second database to the predetermined number of created lowest rankings.

Furthermore, in accordance with embodiments of the present disclosure, a terminal detachably equipped with an external device includes: a storage storing a plurality of song information; an input unit receiving a play command; a controller controlling the storage so as to randomly store a predetermined number of song information among the plurality of song information in a first database of the storage and randomly store the remaining song information of the plurality of song information in a second database of the storage, and reading out audio data from the storage based on the song information stored in the first database, when a command to perform random play is received at the input unit; and a sound output unit outputting the audio data read out by the controller. When a command to play an audio song different from a currently played audio song is received, the controller deletes song information from the first database and adds song information in the second database to the first database.

The first database stores a list of a plurality of song information with matching rankings, the controller may determine song information having higher rankings than song information of the currently played audio song, and when deleting the song information from the first database, the controller may select and delete a predetermined number of song information in correspondence with a predetermined number of rankings from currently played song information among the higher ranking song information.

The first database may store a list of a plurality of song information with matching rankings, and when adding song information in the second database to the first database, the controller may additionally create a lowest ranking in the first database and add a predefined number of song information stored in the second database to the created lowest ranking.

The first database may store a list of a plurality of song information with matching rankings, and when in a random play mode, the controller may determine song information according to a reference ranking among the song information in the first database and control the sound output unit so as to output an audio song for the first time that corresponds to the determined song information according to the reference ranking.

The first database may store a list of a plurality of song information with matching rankings, the controller may update top ranking song information stored in the first database and delete lowest ranking song information from the first database when a command to play a previous song is received, and the controller may delete top ranking song information from the first database and add a predetermined number of song information stored in the second database to the lowest ranking in the first database when a command to play a next song is received.

The first database may store a list of a plurality of song information with matching rankings, the second database may store a plurality of song information and rankings that match the plurality of song information, and when adding song information to the lowest ranking in the first database, the controller may randomly extract the plurality of song information stored in the second database and add song information deleted from the first database to the extracted ranking.

Furthermore, in accordance with embodiments of the present disclosure, a method for controlling a vehicle in communication with an external device includes: randomly storing, by a controller, a predetermined number of song information among a plurality of song information of audio songs in a first database of a storage, when a command to perform random play is received at an input unit; randomly storing, by the controller, the remaining song information of the plurality of song information in a second database of the storage; determining, by the controller, rankings of the song information stored in the first database; and sequentially playing, by the controller, audio songs according to a reference ranking using a sound output unit. The sequentially playing of audio songs includes: determining song information in a ranking to be played, reading out audio data from the storage based on the determined song information, and, when the playing of an audio song is completed, deleting top ranking song information from the first database and adding song information stored in the second database to a lowest ranking in the first database.

The reference ranking may correspond to any of the rankings of the song information stored in the first database excluding the highest and the lowest rankings thereof.

The method may further include: the top ranking song information in the first database when a command to play a previous song is received; and deleting lowest ranking song information in the first database.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 shows the exterior of a vehicle according to embodiments of the present disclosure;

FIG. 2 shows an interior of a vehicle, according to embodiments of the present disclosure;

FIG. 3 is a control block diagram of a vehicle, according to embodiments of the present disclosure;

FIG. 4 is a flowchart illustrating a method for controlling a vehicle, according to embodiments of the present disclosure;

FIG. 5 shows an example of audio files stored in a storage medium connected to a vehicle, according to embodiments of the present disclosure;

FIG. 6 shows an example of a structure of the audio files shown in FIG. 5;

FIG. 7 shows an example of a sequential list of songs in a first database of a first storage in a vehicle when audio function control is performed in a sequential play mode;

FIGS. 8 and 9 show examples of a random list of songs in a first database of a first storage of a vehicle and a waiting list of songs in a second database, when audio function control is performed in a random play mode;

FIGS. 10A and 10B show examples of updates of a random list of songs in a first database of a first storage of a vehicle and a waiting list of songs in a second database, respectively, when audio function control is performed in a random play mode;

FIG. 11 show another example of updates of a random list of songs in a first database of a first storage of a vehicle and a waiting list of songs in a second database, respectively, when audio function control is performed in a random play mode;

FIGS. 12A and 12B show examples of lists of songs in first and second databases, respectively, with respect to a command to play a previous song, when audio function control is performed in a vehicle, according to embodiments of the present disclosure;

FIGS. 13A and 13B show examples of lists of songs in first and second databases, with respect to a command to play a previous song, when audio function control is performed in a vehicle, according to embodiments of the present disclosure;

FIG. 14 shows an example of a random list of songs in a first database when audio function control is performed in a vehicle in a random play mode, according to embodiments of the present disclosure; and

FIG. 15 is a control block diagram of a terminal, according to embodiments of the present disclosure.

### DETAILED DESCRIPTION OF EXEMPLARY EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus (or vehicle) comprising the controller in conjunction with one or more other components, as would be appreciated by a person of ordinary skill in the art.

Furthermore, the controller of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Embodiments of the present disclosure will now be described with reference to accompanying drawings.

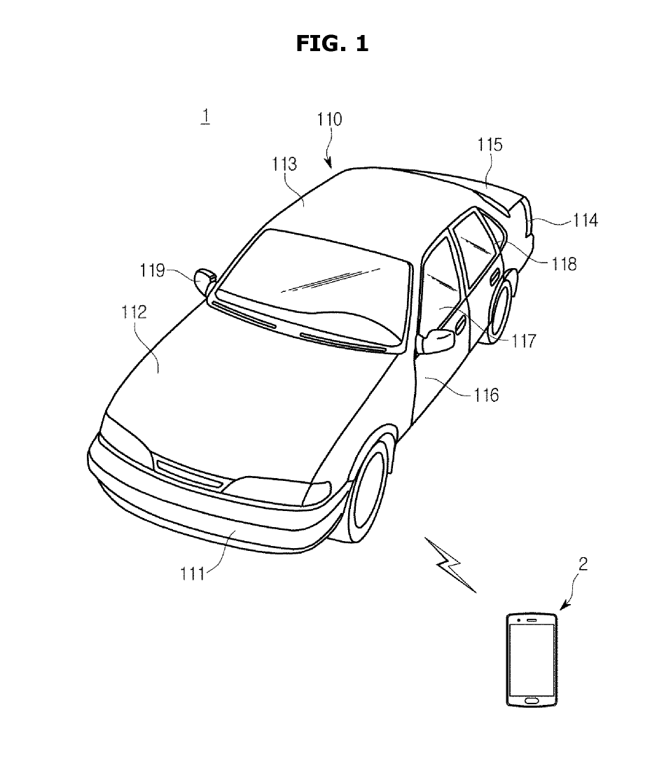

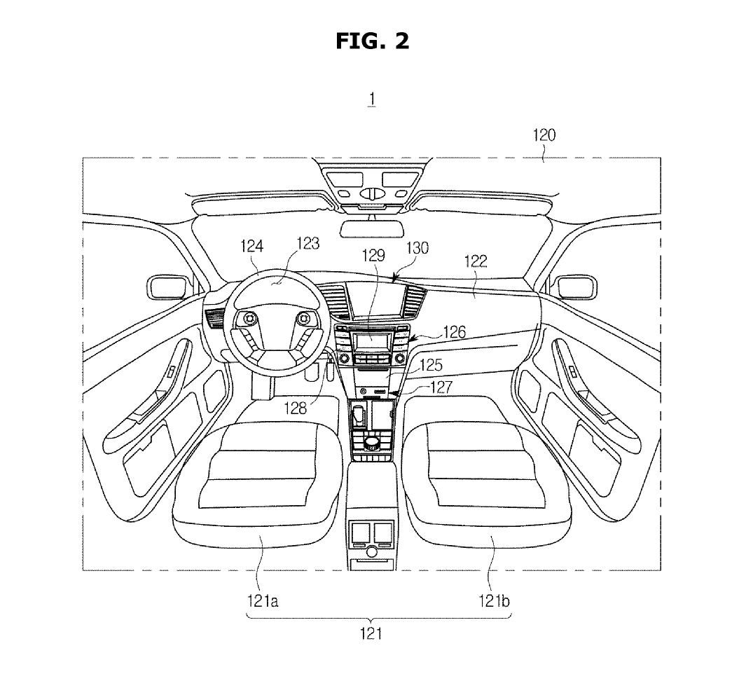

FIG. 1 shows an exterior of a vehicle, according to embodiments of the present disclosure, and FIG. 2 shows an interior of a vehicle, according to embodiments of the present disclosure.

As is generally know, the vehicle 1 moves on the road by driving wheels (e.g., for the purpose of transportation of humans or goods). The vehicle 1 is also able to communicate with a user terminal (UE). The vehicle 1 includes a body with exterior and interior parts, and remaining parts, i.e., chassis on which mechanical devices required for driving are installed.

Referring first to FIG. 1, the exterior part 110 of the body includes a front bumper 111, a hood 112, a roof panel 113, a rear bumper 114, a trunk 115, front, back, left and right doors 116, and window glasses 117 equipped in the front, back, left and right doors 116 to be opened/closed. The exterior part 110 further includes fillers 118 arranged on the boarders between the window glasses mounted on the front, back, left and right doors 116, the front bumper 111, the hood 112, the roof panel 113, the rear bumper 114, and the trunk 115.

Further, the window glasses 117 include side window glasses equipped in the front, back, left and right doors 116, quarter window glasses located between the fillers 118 not to be opened, a rear window glass installed on the back, and a front window glass installed on the front. The exterior part 110 of the body further includes side mirrors 119 that help the driver see areas behind the vehicle 1.

Referring to FIG. 2, the interior part 120 of the body includes seats 121, a dashboard 122, an instrument cluster (or cluster) 123 placed on the dashboard, containing gauges and indicators, such as a tachometer, speedmeter, water temperature gauge, fuel gauge, turn signal indicator, head light indicator, warning light, seat belt warning light, odometer, gearshift position indicator, door open warning light, low fuel warning light, low oil pressure warning light, etc., a steering wheel 124 for steering control of the vehicle, and a center fascia 125 having air vents of an air conditioner (AC), a control pad, and an audio system arranged thereon.

The seats 121 include a driver seat 121a, a passenger seat 121b, and a back seat arranged in the back of the interior of the vehicle 1. The center fascia 125 is located on the dashboard between the driver seat 121a and the passenger seat 121b, and includes a head unit 126 for controlling the AC or the heater and performing an audio function. Air vents, a cigar jack, a vehicle terminal 130, etc., may be installed in the center fascia 125. The vehicle terminal 130 may perform audio, video, Global Positioning System (GPS) or navigation, Digital Multimedia Broadcasting (DMB), and radio functions. The vehicle terminal 130 may also be able to output image data and audio data from external contents stored in a server (not shown) or information stored in a storage medium, and to perform an audio function to output external audio data.

A multi-terminal 127 to enable data communication to be performed between the vehicle terminal 130, the head unit 126, and an external device may also be formed in the center fascia 125. The multi-terminal 127 may be arranged to be adjacent to the head unit 126 or the vehicle terminal 130. The multi-terminal 127 may include a Universal Serial Bus (USB) port to be connected with a USB memory or a USB cable, and an AUX (auxiliary) terminal, and may further include a Secure Digital (SD) slot to have an SD card inserted therein. The multi-terminal 127 may electrically connect a connector or cable to the vehicle terminal 130 or an external device, or may serve as an intermediary to connect the vehicle terminal 130 and the external device to each other.

The external device herein may include a server, a storage medium, a user equipment 2, an MP3 player, etc. The storage medium may include a card-type memory such as an SD memory, a USB memory, external hard disk or optical disk, etc., and the UE 2 may include a smart phone, a laptop, a tablet, or the like. The UE may also serve as a storage medium for storing audio songs when the audio songs stored in the UE are played through the head unit 127. The head unit 127 may further include a disc player (not shown) into which a storage medium, such as an optical disk is inserted.

The vehicle 1 may reproduce audio songs on a storage medium connected to the multi-terminal 127 or a storage medium inserted into the disc player through an audio function of the head unit 126. The vehicle 1 may further include an input unit 128 for receiving user commands and a display 129 for displaying operation information. The input unit 128 may be arranged on the head unit 126, center fascia 125, steering wheel, etc., and the display 129 may be arranged on the head unit 126. The input unit 128 may receive a command to start playing, a command to stop playing, a command to play a previous song, a command to play a next song, a command to perform random play, a command to perform sequential play, and/or the like, and may include a plurality of buttons to receive the commands

The chassis of the vehicle 1 includes a power generating system, a power transfer system, a traveling gear, a steering system, a braking system, a suspension system, a transmission system, a fuel system, front, rear, left, and right wheels, etc. Various types of safety systems are built into the vehicle 1, such as an air back control system for safety of the driver and passenger, an Electronic Stability Control (ESC), etc.

The vehicle 1 includes an Electronic Control Unit (ECU) for controlling operation of the power generating system, power transfer system, traveling gear, steering system, braking system, suspension system, transmission system, fuel system, various safety systems and detection devices. The vehicle 1 may further include an engine start button to provide an operation instruction to a start motor (not shown). Specifically, pushing the engine start button drives the start motor, which in turn drives the power generating system, i.e., an engine (not shown).

The vehicle 1 further includes a battery (not shown) electrically connected to the vehicle terminal, head unit, indoor lights, start motor, and other electronic devices, for supplying power. The battery is charged by means of dynamic power of the internal generator or the engine while the vehicle is being driven.

For example, the vehicle 1 may be electrically connected to a storage medium, such as a USB memory, an SD card, or an optical disk for reading out and playing a plurality of audio songs from the storage medium.

It should be understood that the exterior and interior configurations of the vehicle 1 demonstrated in FIGS. 1 and 2, respectively, are provided merely for demonstration purposes and should not be treated as limiting the scope of the present disclosure. Rather, the vehicle 1 may be configured in any suitable manner in accordance with the claims set forth herein.

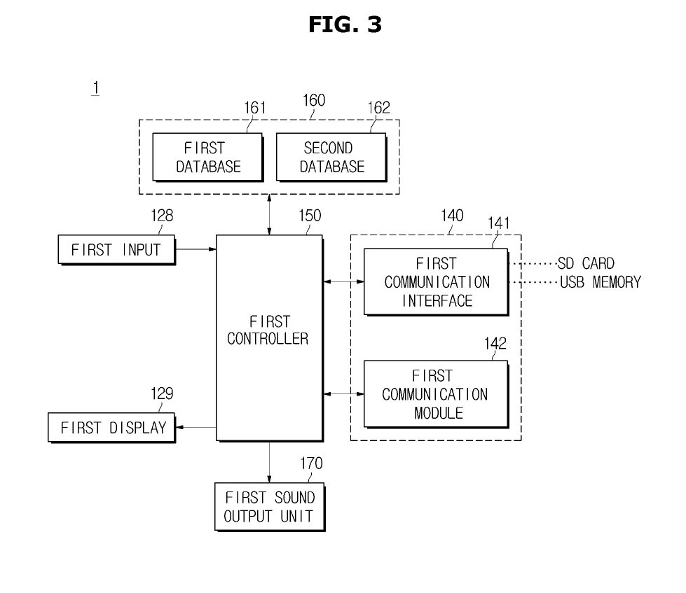

Control configuration of the vehicle will now be described in connection with FIG. 3.

FIG. 3 is a control block diagram of a vehicle, according to embodiments of the present disclosure, the vehicle including a first input unit 128, a first display 129, a first communication unit 140, a first controller 150, a first storage 160, and a first sound output unit 170.

To differentiate components of the vehicle from those of a terminal as will be described later, the term “first” is attached to the names of the components of the vehicle.

The first input unit 128 may receive a “play” command and forward the play command to the first controller 150, while an audio function is performed.

The play command may include a command to start playing, a command to stop playing, a command to play a previous song, a command to play a next song, a command to perform random play, and a command to perform sequential play.

The first display 129 may display information about a title, an artist name, playing time, etc., of the song being played while the audio function is performed.

The first communication unit 140 may perform communication with an external device, such as a storage medium or a user equipment (UE). The first communication unit 140 may include a first communication interface 141 connected to the USB port, SD slot, or AUX terminal for receiving signals transmitted through the USB port, SD slot, or AUX terminal and forwarding the signals to the first controller 150, and a first communication module 142 for performing wired or wireless communication with a server (not shown), an electronic device inside the vehicle, or a UE.

The first communication interface 141 may be electrically, mechanically, and/or communicatively connected to a USB memory or a USB cable through the USB port, or may be electrically, mechanically, and/or communicatively connected to an SD card through the SD slot.

In this case, the other end of the USB cable may be connected to the UE.

The first communication module 142 may include a short-range wireless communication unit, a mobile communication unit, a wireless local area network (WLAN) unit, a Wireless Fidelity (Wi-Fi) unit, etc.

The short-range wireless communication unit may include a bluetooth unit, a near field communication (NFC) unit, a radio frequency (RF) unit, etc., and the mobile communication unit may include a long term evolution (LTE) unit, a code division multiple access (CDMA) unit, wide CDMA (WCDMA) unit, etc.

In the following description of the first controller 150, the first storage 160, and the first sound output unit 170, the USB memory, the optical disk, the UE, the SD card, the MP3 player, etc., which store a plurality of audio songs, will be collectively called a storage medium.

The first controller 150 may determine whether a play command has been received through the first input unit 128 when a storage medium is connected wiredly or wirelessly through the first communication unit 140, if it is determined that the command to play audio songs has been received, may read song information of the audio songs stored in the storage medium and store the song information in the first storage 160, and read out audio data from the storage medium based on the order in which the information is stored in the first storage and control the audio data to be output through the first sound output unit 170.

Alternatively, the first controller 150 may read the song information of the audio songs stored in the storage medium and store them in the first storage 160 when the storage medium is connected wiredly or wirelessly through the first communication unit 140 without a performing a process of determining whether a play command has been received through the first input unit 128, and read out audio data from the storage medium based on the order in which the song information is stored in the first storage and control the audio data to be automatically output through the first sound output unit 170.

It is also possible for first controller 150 to determine whether a play command has been received through the first input unit 128 when an optical disk is inserted into a disc player (not shown), read song information of the audio songs stored in the optical disk and store the song information in the first storage 160, read out audio data from the optical disk based on the order in which the song information is stored in the first storage 160 and control the audio data to be output through the first sound output unit 170.

More specifically, if the play command corresponds to a command to perform sequential play, the first controller 150 may control the song information of audio songs stored in the storage medium to be stored in the first storage 160 in a predetermined order. The predetermined order herein refers to an order in which the plurality of audio songs are stored in the storage medium.

In other words, the first controller 150 may control the song information to be stored in the same order as they are stored in the storage medium, and in particular, may control rankings and the matching song information to be stored in a list.

The first controller 150 may store the list in one of a first database 161 and a second database 162 in the first storage 160.

If the play command corresponds to a command to perform random play, the first controller 150 may store a predetermined number of song information among the plurality of song information stored in the storage medium in the first database 161 in the first storage 160 while storing the remaining song information among the plurality of song information in the second database 162 in the first storage 160.

In other words, the first controller 150 may store the song information randomly in the first database 161 by storing the song information and the matching rankings in a random list, and store the remaining song information in the second database 162 by storing the song information and the matching rankings in a waiting list.

Furthermore, the first controller 150 may store about 80% of song information stored in the storage medium in the first database and store the remaining 20% of the song information in the second database, in the random play mode.

The first controller 150 may identify song information in a ranking to be played among the plurality of song information stored in the first database 161, and read out audio data corresponding to the identified song information from the storage medium.

To select an audio song to be played for the first time in the random play mode, the first controller 150 checks the rankings of the plurality of songs stored in the first database 161, determines a reference ranking among the rankings of the plurality of the song information, and controls the songs from the reference ranking to be sequentially played,

The reference ranking may be any of the rankings of the plurality of song information stored in the first database 161 excluding the highest and the lowest rankings.

For example, the reference ranking may be a middle one among the rankings of the plurality of song information in the first database 161. After the playing of an audio song of any song information is completed, the first controller 150 may delete another song information among the plurality of song information from the first database 161 and add one of the plurality of song information in the second database 162 to the first database 161.

In this case, the first controller 160 may add the song information deleted from the first database 161 to the second database 162, and delete the song information added to the first database 161 from the second database 162. In this way, the first controller 160 may update song information in the first and second databases 161 and 162 whenever the audio song to be played is changed.

An example of updating a random song list in the first database 161 will now be described.

After the playing of an audio song is completed, the first controller 150 may delete the top ranking song information stored in the first database 161 and add one of the plurality of song information stored in the second database 162 to the lowest ranking in the first database 161.

If the play command corresponds to a command to play a previous song, the first controller 150 may update the top ranking song information stored in the first database 161 and delete the lowest ranking song information from the first database 161.

When a command to play a next song is input, the first controller 150 may delete the top ranking song information stored in the first database 161 and add one of the plurality of song information stored in the second database 162 to the lowest ranking in the first database 161.

In adding the song information to the lowest ranking in the first database 161, the first controller 150 may sequentially extract the plurality of song information stored in the second database 162 in the order of rankings, and add the song information deleted from the first database to the extracted ranking.

In adding the song information to the lowest ranking in the first database 161, the first controller 150 may randomly extract one of the plurality of song information stored in the second database 162, and add the song information deleted from the first database 161 to the ranking that matches the extracted song information.

Another example of updating a random song list in the first database 161 will now be described.

After the playing of an audio song is completed, the first controller 150 may delete another song information stored in the first database 161 and add one of the plurality of song information stored in the second database 162 to the first database 161.

In deleting another song information from the first database 161, the first controller 150 may identify song information in higher rankings than the ranking of the currently played song information, and select and delete one of the higher ranking song information, which is at a distance of a certain rankings from the currently played song information. In this case, the first controller 150 may delete the ranking that matches the deleted song information as well.

A predetermined number of previous and next songs that the user is able to memorize with respect to the currently played audio song may be set by the user or a manufacturer in advance. Alternatively, the predetermined number of the songs may be set based on the total number of song information stored in the first database 161.

In adding one song information in the second database 162 to the first database 161, the first controller 150 may additionally create a lowest ranking in the first database 161 and add one of the plurality of song information stored in the second database 162 to the created lowest ranking in the first database 161.

Furthermore, in adding one of the plurality of song information in the second database 162 to the first database 161, it is also possible for the first controller 150 to check lower ranking song information than the ranking of the currently played song information, additionally create a ranking between the ranking of the currently played song information and a ranking at a distance of a certain number of rankings from the ranking of the currently played song information, and add one song information in the second database 162 to the created ranking in the first database 161.

If the play command corresponds to a command to play a previous song, the first controller 150 may update the rank and the matching song information deleted from the first database when the audio song currently stopped being played had been played, and deletes the rank and the matching song information added to the first database 161 when the audio song currently stopped being played is to be played.

If the play command corresponds to a command to play a next song, the first controller 150 may control the next song to be played, add a highest ranking and the matching song information in the first database 161, create a ranking next to the lowest ranking in the first database 161, and add song information to the created ranking.

The first controller 150 may be a central processing unit (CPU) or micro controller unit (MCU), a processor, or an ECU built into the vehicle 1.

The first storage 160 may store song information stored in a storage medium in response to a command from the first controller 150. The first storage 160 may include the first database 161 and the second database 162. The first database 161 may store a list of a plurality of rankings and the respective matching song information. In the random play mode, the list stored in the first database 161 may be a random list. The second database 162 may store a plurality of song information to be stored in the first database 161 in the random play mode. The second database 162 may store a list of a plurality of rankings and the respective matching song information as a waiting list.

The first storage 160 may include a single memory that has both functions of the first and second databases 161 and 162, or may include a plurality of memories each having the function of the first or second database 161 or 162. The memory may include volatile memories, such as Static Random Access Memories (S-RAMs), Dynamic RAMs (D-RAMs), or the like, and non-volatile memories, such as Read Only Memories (ROMs), Erasable Programmable ROMs (EPROMs), Electrically Erasable Programmable ROMs (EEPROMs), or the like.

The first sound output unit 170 may output audio data based on a command from the first controller 150.

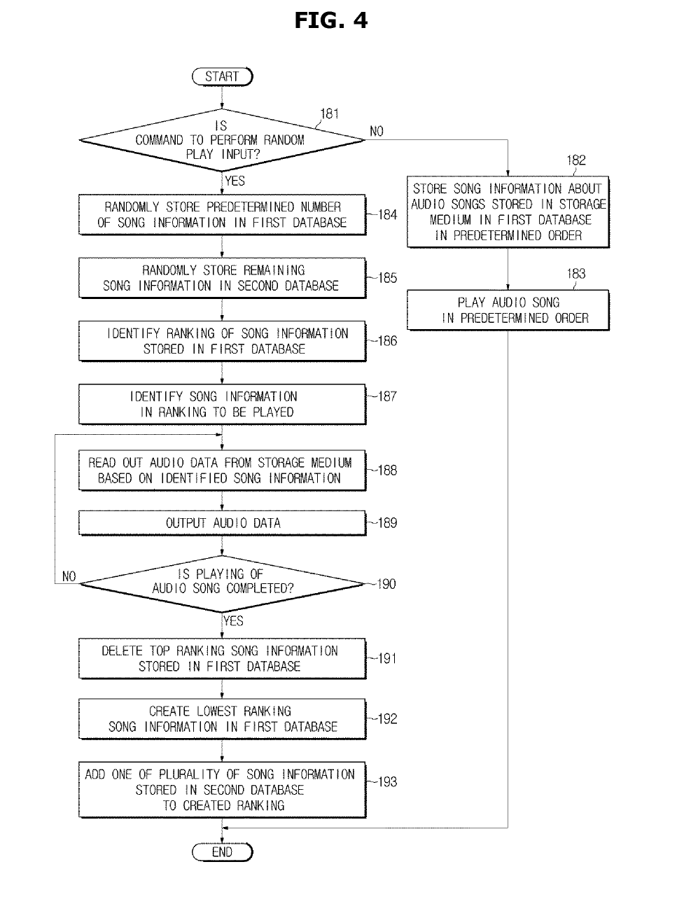

A flowchart illustrating a method for controlling an audio function of the vehicle will now be described in connection with FIG. 4.

First, the vehicle determines whether a command to perform random play has been received while connected to a storage medium in operation 181. If it is determined that the command to perform random play has not been received, the vehicle controls sequential play.

Specifically, the vehicle stores song information of a plurality of audio songs stored in the storage medium in the first database 161 in a predetermined order, in operation 182. The vehicle then sequentially plays audio songs based on the song information in the first database by sequentially playing the audio songs in the predetermined order, in operation 183.

In this case, the vehicle identifies a ranking to be currently played, identifies song information corresponding to the identified ranking, and read out audio data stored in the storage medium based on the identified song information.

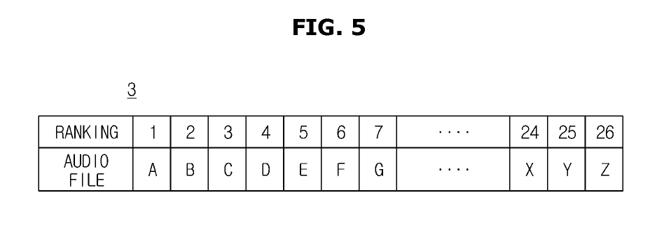

This will be described in connection with FIGS. 5 to 7.

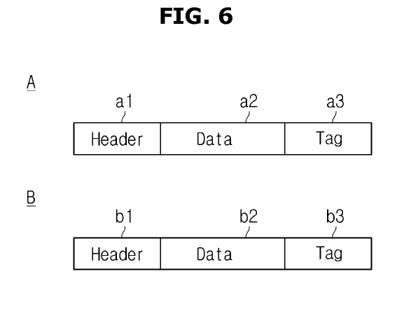

FIG. 5 shows an example of audio files stored in a storage medium connected to a vehicle, according to embodiments of the present disclosure, and FIG. 6 shows an example of a structure of the audio files shown in FIG. 5.

Referring first to FIG. 5, a storage medium 3 may store a plurality of audio files of audio songs.

The storage medium 3 may store the plurality of audio files by matching them to their respective rankings. For example, the storage medium 3 may store a total of 26 audio files A, B, C, D, . . . , Z by matching them to first to 26'th rankings, respectively.

The audio files stored in the storage medium 3 may have predetermined formats and information corresponding to the predetermined formats. For example, it is common for the audio file to have a compressed file format, such as an MPEG1 Audio Layer 2 (MP2) format, MPEG1 Audio Layer 3 (MP3) format, etc., or a non-compressed wave file format.

Among them, the audio files in the MP3 format may have the structure as shown in FIG. 5. Among the plurality of audio files, audio files A and B will be taken as an example.

Referring next to FIG. 6, the audio file A has a file structure including 4 bytes of header information a1, N bytes of data information a2, and 128 bytes of tag information a3.

The audio file B also has a file structure having 4 bytes of header information b1, N bytes of data information b2, and 128 bytes of tag information b3. That is, the plurality of audio files stored in the storage medium may have the same structure.

The header information a1, b1 includes navigation information (called song information), such as a length of each data in the MP3 file, and the tag information a3, b3 includes audio song information about the MP3 file, e.g., audio song title information, artist name information, and additional information such as lyrics information. The data information a2, b2 includes respective audio data about the audio songs.

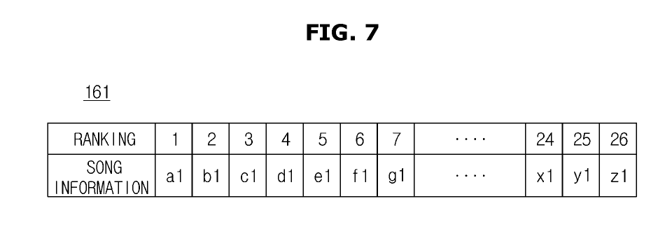

FIG. 7 shows an example of a sequential list of songs in a first database of a first storage when audio function control is performed in a sequential play mode.

If it is determined that the play command corresponds to a command to perform sequential play, the vehicle reads and stores song information of the audio files stored in a storage medium with the respective rankings matching with the audio files.

Specifically, if audio files A, B, C, . . . , and Z are stored in the storage medium in the first to 26th rankings, respectively (e.g., see FIG. 5), respective song information a1 to z1 corresponding to the plurality of audio files A to Z is stored in the first database 161 in the matching rankings. That is, the song information a1 is stored in the first ranking, the song information b1 in the second ranking, the song information c1 in the third ranking, . . . , and the song information z1 in the 26'th ranking in the first database 161.

As such, in response to an input of the command to perform sequential play, the vehicle may fetch the rankings of the audio files stored in the storage medium, store them in the first database 161 in the same order, and sequentially play the audio songs based on the rankings and the song information stored in the first database 161.

If it is determined that a command to perform random play has been received, the vehicle randomly stores song information of a predetermined number of audio files in the first database 161 among the plurality of audio files stored in the storage medium, in operation 184.

The vehicle then randomly stores song information of the remaining audio files in the second database among the plurality of the audio files stored in the storage medium, in operation 185.

Subsequently, the vehicle identifies the rankings of the predetermined number of song information stored in the first database, in operation 186, and identifies a reference ranking to be played for the first time, in operation 187.

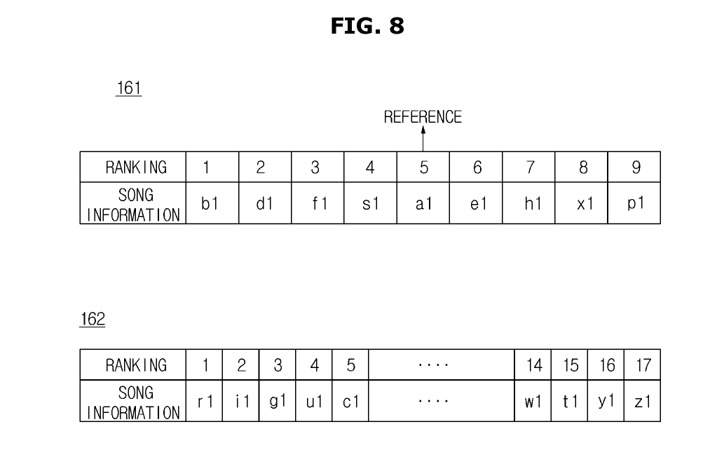

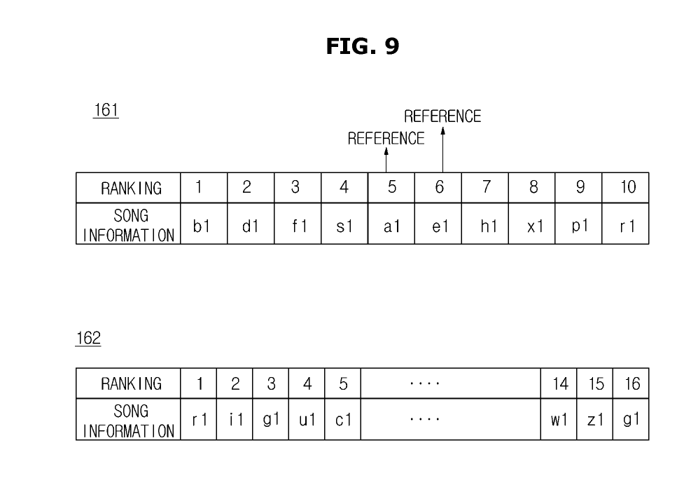

This will be described with reference to FIGS. 8 and 9.

For example, about 80% of song information stored in the storage medium may be stored in the first database and the remaining 20% of song information may be stored in the second database in the random play mode, without being limited thereto.

For convenience of explanation, reference to drawings that do not reflect this configuration will be made.

FIG. 8 shows the first database with an odd number of song information stored therein, and FIG. 9 shows the first database with an even number of song information stored therein.

Referring first to FIG. 8, assume that an odd number of song information (e.g., 9 song information items) is stored in the first database.

The vehicle creates a random list of song information by randomly matching the selected song information to the first to ninth rankings in the first database, and creates a waiting list of song information by randomly matching the remaining song information to the first to seventeenth rankings in the second database.

In other words, the first database stores the song information matching the first to ninth rankings, and the second database stores the song information matching the first to seventeenth rankings.

In this case, the middle ranking of the plurality of rankings in the first database is the fifth ranking, which is the reference ranking.

As such, the number of song information to be stored in the first database is set in advance, and accordingly, the reference ranking is also set in advance.

Referring next to FIG. 9, assume that an even number of song information (e.g., 10 song information items) is stored in the first database.

The vehicle creates a random list of song information by randomly matching the selected song information to the first to tenth rankings in the first database, and creates a waiting list of song information by randomly matching the remaining song information to the first to sixteenth rankings in the second database. In other words, the first database stores the song information matching the first to tenth rankings, and the second database stores the song information matching the first to sixteenth rankings. In this case, the middle rankings of the plurality of rankings in the first database are the fifth and sixth rankings, one of which is selected as the reference ranking. This reference ranking may also be set in advance.

The vehicle identifies song information that corresponds to the reference ranking, and reads out audio data from the storage medium based on the identified song information in operation 188 and outputs the audio data in operation 189.

Furthermore, after the playing of the first audio song is completed, the vehicle determines a ranking to be next played, identifies song information that corresponds to the determined ranking, and reads out audio data from the storage medium based on the identified song information in operation 188 and outputs the audio data in operation 189. In this case, the vehicle reads out and plays MP3 audio data recorded in data information by referring to navigation information included in the song information, and also retrieves, reads out, and displays additional information, such as an audio song title, an artist name, lyrics information included in the tag information.

Furthermore, if an optical disk is inserted into the disc player, the first controller 150 of the vehicle may control operation of the disc player to read song information recorded in the read-in area of the optical disk (e.g., navigation information) and store the song information in the first database, to read out and play audio data that corresponds to the song information sequentially from the reference ranking, and to read and display text data and various additional information corresponding to the audio data.

After the playing of the audio song is completed in operation 190, the vehicle deletes the top ranking song information stored in the first database in operation 191, creates a ranking lower than the lowest ranking in the first database in operation 192, and adds one of the plurality of song information stored in the second database to the created ranking, in operation 193.

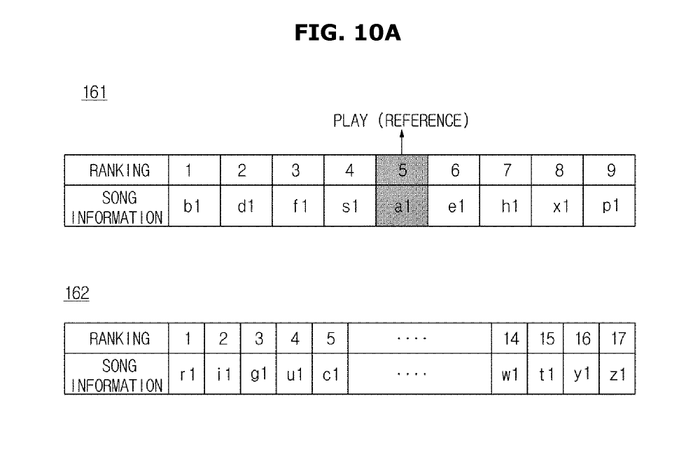

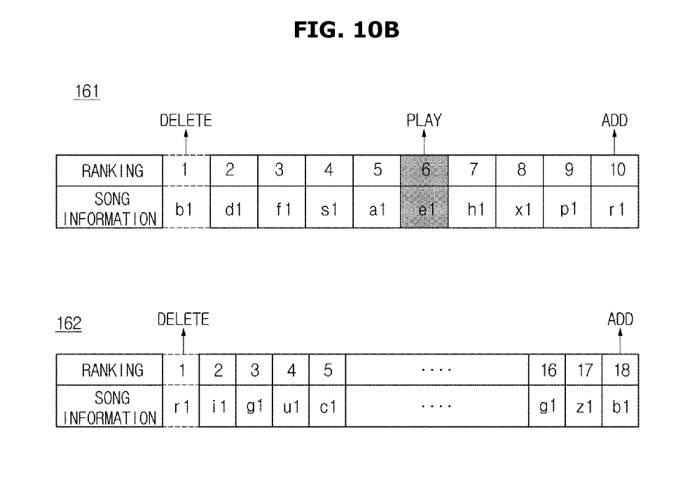

An example of the operations 186 to 193 will be described in connection with FIGS. 10A and 10B.

Referring first to FIG. 10A, the vehicle identifies song information that matches the reference ranking, e.g., the fifth ranking in the first database, reads out audio data that corresponds to the identified song information a1 from the storage medium, and converts and outputs the audio data in sound.

The audio data may include all of the header information a1, data information a2, which corresponds to data, and tag information a3.

Referring next to FIG. 10B, after the playing of the audio song corresponding to the song information in the fifth ranking is completed, the vehicle determines a ranking next to the fifth ranking, identifies song information e1 in the next ranking, i.e., in the sixth ranking, reads out audio data corresponding to the song information e1 from the storage medium, and converts and outputs the audio data in sound.

In this case, the vehicle deletes the top ranking, i.e., the first ranking and the matching song information from the first database, newly creates a lowest ranking in the first database, and adds new song information r1 to the newly created lowest ranking, i.e., the tenth ranking.

The new song information in the tenth ranking is one of the plurality of song information stored in the second database, which is in particular, the top ranking song information in the second database.

The vehicle deletes the top ranking song information from the second database, newly creates a lowest ranking, and adds the song information b1 deleted from the first database to the newly created lowest ranking, i.e., eighteenth ranking.

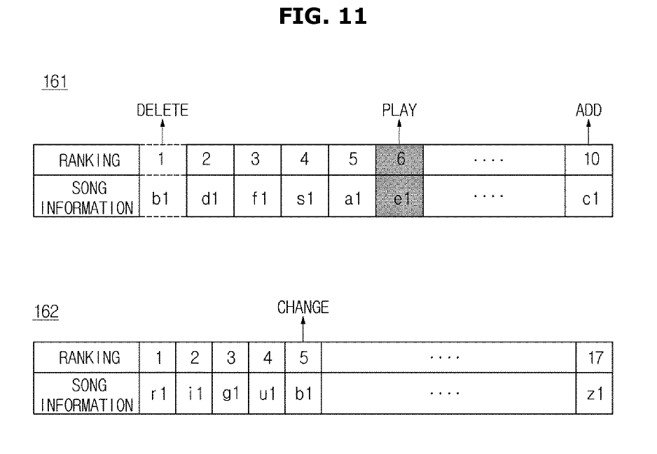

Another example of the operations 186 to 193 will be described in connection with FIG. 11.

As shown in FIG. 11, after the playing of the audio song corresponding to the song information in the fifth ranking is completed, the vehicle determines a ranking next to the fifth ranking, identifies song information e1 in the next ranking, i.e., in the sixth ranking, reads out audio data corresponding to the song information e1 from the storage medium, and converts and outputs the audio data in sound.

In this case, the vehicle deletes the top ranking, i.e., the first ranking and the matching song information from the first database, newly creates a lowest ranking in the first database, and adds new song information c1 to the newly created lowest ranking, i.e., the tenth ranking.

The new song information in the tenth ranking is a piece of song information randomly selected from among the plurality of song information stored in the second database.

The vehicle selects one of the plurality of rankings in the second database, deletes song information in the selected ranking, changes the song information in the selected ranking, e.g., fifth ranking, to the song information b1 deleted from the first database.

When a command to play a previous song or next song is input to the first input unit while an audio song is currently being played, the vehicle plays a song previous or next to the audio song currently being played, based on the input command.

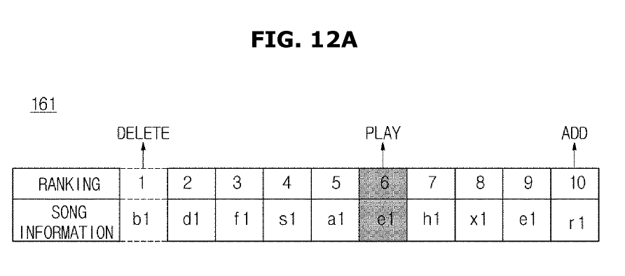

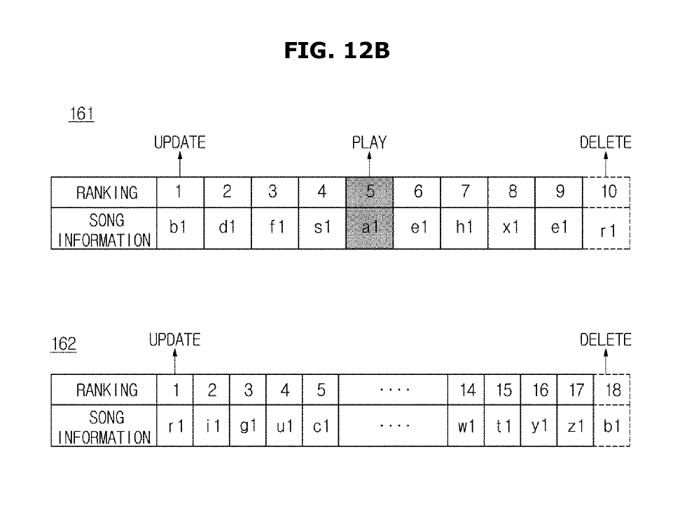

A database structure relating to the command to play a previous song will be described in connection with FIGS. 12A and 12B.

Referring first to FIG. 12A, when a command to play a previous song is input while the vehicle is reading out and outputting audio data in sound, which corresponds to the song information e1 in the sixth ranking in the first database, the vehicle determines a ranking previous to the sixth ranking of the currently played audio song.

Referring next to FIG. 12B, the vehicle identifies the song information al that matches the fifth ranking previous to the sixth ranking in the first database, reads out audio data that corresponds to the identified song information a1 from the storage medium, and converts and outputs the audio data in sound.

At this time, the vehicle determines the ranking and song information deleted from the first database while playing the audio song corresponding to the song information in the sixth ranking in the first database, and updates the deleted ranking, e.g., first ranking, and song information, e.g., b1, and determines the ranking and song information added to the first database while playing the audio song corresponding to the song information in the sixth ranking and deletes the added ranking, e.g., tenth ranking, and song information r1.

Furthermore, the vehicle determines the ranking and song information deleted from the second database while playing the audio song corresponding to the song information in the sixth ranking in the first database and updates the deleted ranking, e.g., first ranking and song information, e.g., r1, and determines the ranking and song information added to the second database while playing the audio song corresponding to the song information in the sixth ranking in the first database and deletes the added ranking, e.g., eighteenth ranking, and song information b1.

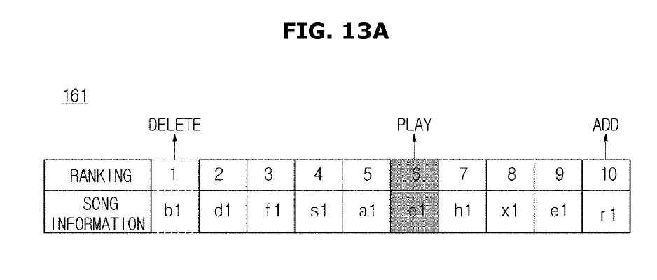

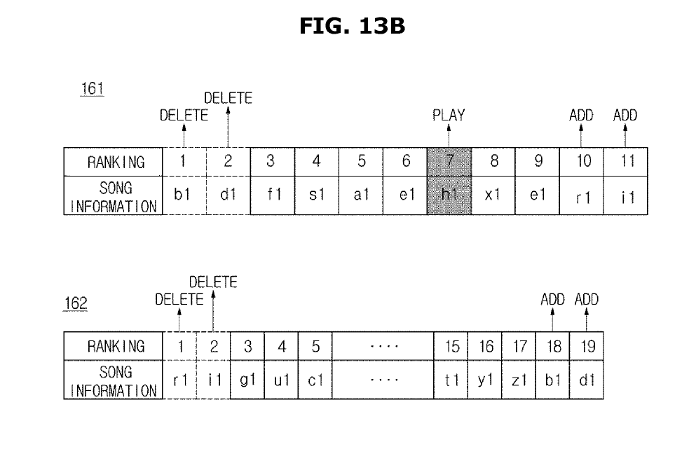

A database structure relating to the command to play a next song will be described in connection with FIGS. 13A and 13B.

Referring to FIG. 13A, when a command to play a next song is input while the vehicle is reading out and outputting audio data in sound, which corresponds to the song information e1 in the sixth ranking in the first database, the vehicle determines a ranking next to the sixth ranking of the currently played audio song.

Referring first to FIG. 13B, the vehicle identifies the song information h1 that matches the seventh ranking next to the sixth ranking in the first database, reads out audio data that corresponds to the identified song information h1 from the storage medium, and converts and outputs the audio data in sound.

At this time, the vehicle identifies the top ranking in the first database while playing an audio song corresponding to the song information h1 in the seventh ranking in the first database, deletes the identified top ranking, creates a ranking next to the lowest ranking, i.e., the eleventh ranking in the first database, and adds and stores new song information i1 to the created eleventh ranking.

The new song information added to the eleventh ranking in the first database is one of the plurality of song information stored in the second database. This may be the top ranking song information stored in the second database.

Alternatively, the new song information to be added to the eleventh ranking in the first database may be one randomly selected from among the plurality of song information in the second database.

Referring next to FIG. 13B, the vehicle deletes the top ranking and the matching song information from the second database while playing an audio song corresponding to the song information in the seventh ranking in the first database, creates a ranking next to the lowest ranking in the second database, and stores the song information d1 deleted from the first database in the created ranking, i.e., the nineteenth ranking.

Although in the embodiment song information stored in the first database is deleted one by one or added one by one, the song information may be deleted or added by a predetermined number (e.g., at least two or more) of pieces of song information in some embodiments.

In this way, the vehicle may maintain the number of song information stored in the first database even when the command to play a next or previous song is input while an audio song is currently being played, and may maintain the order of a certain number of song information in the previous and next rankings with respect to an audio song to be played.

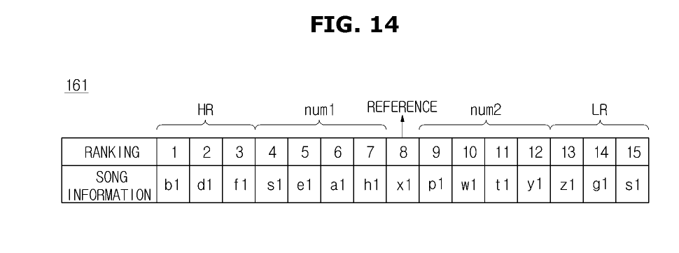

FIG. 14 shows an additional example of a random list of songs in a first database when audio function control is performed in a vehicle in a random play mode, according to embodiments of the present disclosure.

When the command to perform random play is input, the vehicle randomly stores a predetermined number of song information in the first database from among the plurality of song information stored in the storage medium while randomly storing the remaining song information in the second database of the storage, and reads out audio data from the storage medium based on the plurality of song information stored in the first database.

Furthermore, the middle ranking of the plurality of rankings in the first database may be set to the reference ranking.

After the playing of the current audio song is completed, the vehicle identifies the ranking of the song information that has just been played, and classifies the plurality of rankings in the first database into higher rankings (HRs) and lower rankings (LRs) based on the identified ranking.

The vehicle deletes one of the higher rankings at a distance of more than a certain number (num1) of rankings from the ranking of the song information that has just been played, newly creates a ranking among the lower rankings at a distance of more than a certain number (num2) of rankings from the ranking of the song information that has just been played, and adds song information to the created ranking.

The certain numbers num1 and num2 are the number of previous songs and the number of next songs, respectively, that the user is able to memorize, which may be the same or different from each other.

For example, if the song information that has just been played is placed in the eighth ranking, the vehicle distinguishes higher rankings, e.g., the first to seventh rankings, from lower rankings, e.g., the ninth to fifteenth rankings with respect to the eighth ranking, identifies a certain number (num1) of rankings, e.g., the fourth and fifth rankings, adjacent to the eighth ranking among the higher rankings, identifies a certain number (num2) of rankings, e.g., the ninth to twelfth rankings, adjacent to the eighth ranking among the lower rankings, and identifies the lower rankings, e.g., thirteenth to fifteenth rankings distanced from the eighth ranking.

The vehicle then deletes one of the first to third higher rankings distanced from the eighth ranking, and creates a new ranking among the thirteenth to fifteenth lower rankings distanced from the eighth ranking.

Furthermore, the vehicle may create a sixteenth ranking next to the lowest fifteenth ranking among the lower rankings.

In playing the previous song in response to an input through the first input unit, the vehicle may update the ranking and song information deleted when the current audio song is played, and delete an added ranking and song information. This operation is the same as what is described above, so no further description will be provided herein.

In playing the next song in response to an input through the first input unit, operations of adding and deleting song information to and from the first database are the same as those performed when the next song is to be played after the playing of the current audio song is completed, so the description will be omitted herein.

Operations of addition and deletion of the rank and song information to and from the second database are the same as what is described above, so the description will also be omitted herein.

In this way, the vehicle may maintain a constant number of song information stored in the first database even when a command to play a next or previous song, or a command to repeatedly play a section is input while an audio song is currently being played, and may maintain the order of certain numbers of song information in previous and next rankings (num1, num2) with respect to an audio song to be played.

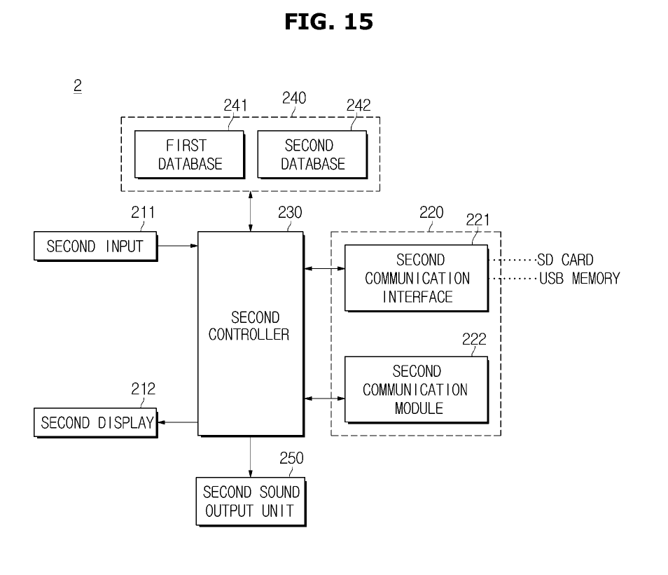

FIG. 15 is a control block diagram of a terminal, according to embodiments of the present disclosure, the terminal 2 including a second input unit 211, a second display 212, a second communication unit 220, a second controller 230, a second storage 240, and a second sound output unit 250. The terminal 2 may include a smart phone, a tablet, a laptop, etc. To differentiate components of the terminal 2 from those of the vehicle 1, the term “second” is attached to the names of the components of the terminal 2.

The second input unit 211 may receive a play command and forward the play command to the second controller 230, while an audio function is performed. The play command may include a command to start playing, a command to stop playing, a command to play a previous song, a command to play a next song, a command to repeatedly play a section, a command to perform random play, a command to perform sequential play, etc.

The second display 212 may display information about a title, an artist name, playing time, etc., of the song being played while the audio function is performed. The second input unit 211 may be implemented by a touch panel, and the second display 212 may be implemented by a flat display panel. Alternatively, the second input unit 211 and the second display 212 may be implemented in a single touch screen.

The second communication unit 220 may perform communication with an external device, such as a storage medium. The second communication unit 220 may include a second communication interface 221 connected to a USB port, an SD slot, or an AUX terminal for receiving signals transmitted through the USB port, the SD slot, or the AUX terminal and forwarding the signals to the second controller 230, and a second communication module 222 for performing wired or wireless communication with a server (not shown).

The second communication interface 221 may be electrically, mechanically, and/or communicatively connected to a USB memory or a USB cable through the USB port, or may be electrically, mechanically, and/or communicatively connected to an SD card through the SD slot. The second communication module 222 may include a short-range wireless communication unit, a mobile communication unit, a wireless local area network (WLAN) unit, a Wireless Fidelity (Wi-Fi) unit, etc. The short-range wireless communication unit may include a bluetooth unit, a near field communication (NFC) unit, a radio frequency (RF) unit, etc., and the mobile communication unit may include a long term evolution (LTE) unit, a code division multiple access (CDMA) unit, wide CDMA (WCDMA) unit, etc.

In the following description of the second controller 230, the second storage 240, and the second sound output unit 250, external devices, such as the USB memory and the SD card, which store a plurality of audio songs, will be collectively called a storage medium.

The second controller 230 may determine whether a command to play an audio song has been received through the second input unit 221 when a storage medium is connected wiredly or wirelessly through the second communication unit 230, if it is determined that the command to play an audio song has been received, may read song information of audio songs stored in the storage medium and store the song information in the second storage 240, and read out audio data from the storage medium based on the order in which the song information is stored in the second storage 240 and control the audio data to be output through the second sound output unit 250.

More specifically, if the play command corresponds to a command to perform sequential play, the second controller 230 may control a plurality of song information of audio songs stored in the storage medium to be stored in the second storage in a predetermined order.

The predetermined order herein refers to an order in which the plurality of audio songs are stored in the storage medium.

In other words, the second controller 230 may control the song information to be stored in the same order in which the songs are stored in the storage medium, and in particular, may store rankings and pieces of song information that match the rankings in a list.

The second controller 230 may store the list in one of a first database 241 and a second database 242 in the second storage 240.

If the play command corresponds to a command to perform random play, the second controller 230 may store a predetermined number of song information among the plurality of song information stored in the storage medium in the first database 241 of the second storage while storing the remaining song information among the plurality of the song information in the second database 242 of the second storage.

In other words, the second controller 230 may store the song information randomly in the first database 241 by storing rankings and the matching song information in a random list, and store the remaining song information in the second database 242 by storing rankings and the matching song information in a waiting list.

Furthermore, the second controller 230 may store about 80% of song information stored in the storage medium in the first database 241 and store the remaining 20% of song information in the second database 242 in the random play mode.

The second controller 230 may identify the song information in a ranking to be played among the plurality of song information stored in the first database 241, and read out audio data corresponding to the identified song information from the storage medium.

To select an audio song to be played for the first time in the random play mode, the second controller 230 identifies the rankings of the plurality of song information stored in the first database 241, determines a reference ranking among the rankings of the plurality of the song information, and controls the songs to be sequentially played from the reference ranking,

The reference ranking may be any of the rankings of the plurality of song information stored in the first database 241 excluding the highest and the lowest rankings.

Alternatively, the reference ranking may be a middle one among the rankings of the plurality of song information in the first database 241.

After the playing of an audio song of some song information is completed, the second controller 230 may delete another song information among the plurality of song information in the first database 241 and add one of the plurality of song information in the second database 242 to the first database 241.

In this case, the second controller 230 may add the song information deleted from the first database 241 to the second database 242, and delete song information added to the first database 241 from the second database 242.

In this way, the second controller 160 may update song information in the first and second databases 241 and 242 whenever the audio song to be played is changed.

After the playing of an audio song is completed, it is also possible for the second controller 230 to delete the top ranking song information stored in the first database 241 and add one of the plurality of song information stored in the second database 242 to the lowest ranking in the first database 241.

If the play command corresponds to a command to play a previous song, the second controller 230 may update the top ranking song information stored in the first database 241 and delete the lowest ranking song information from the second database 242.

When the command to play a next song is input, the second controller 230 may delete the top ranking song information from the first database 241, create a ranking next to the lowest ranking in the first database 241, and add one of the plurality of song information stored in the second database 242 to the created ranking in the first database 241.

In adding the song information to the lowest ranking in the first database 241, the second controller 230 may sequentially extract the plurality of song information stored in the second database 242 in the order of the rankings, and add the song information deleted from the first database 241 to the extracted ranking.

In adding the song information to the lowest ranking in the first database 241, it is also possible for the second controller 230 to randomly extract one of the plurality of song information stored in the second database 242, and add the song information deleted from the first database 241 to the ranking that matches the extracted song information.

In this way, the terminal 2 may maintain a constant number of song information stored in the first database 241 even when the command to play a next or previous song is input while an audio song is currently being played, and may maintain the order of a certain number of song information in the previous and next rankings with respect to an audio song to be played.

The configuration of the second controller 230 is the same as the configuration of the first controller 230, so the detailed description thereof will be omitted herein. The second controller 230 may be a CPU or MPU, or may be a processor.

The second storage 240 may store song information stored in a storage medium in response to a command from the second controller 230. The second storage 240 may include the first database 241 and the second database 242.

The first database 241 may store a list of a plurality of rankings and the respective matching song information. In the random play mode, the list stored in the first database 241 may be a random list.

The second database 242 may store a plurality of song information to be stored in the first database 241 in the random play mode. The second database 242 may store a list of a plurality of rankings and the respective matching song information as a waiting list. The second storage 240 may include a single memory that has both functions of the first and second databases 241 and 242, or may include a plurality of memories each having the function of the first or second database 241 or 242. The memory may include volatile memories, such as Static Random Access Memories (S-RAMs), Dynamic RAMs (D-RAMs), or the like, and non-volatile memories, such as Read Only Memories (ROMs), Erasable Programmable ROMs (EPROMs), Electrically Erasable Programmable ROMs (EEPROMs), or the like.

The second sound output unit 250 may output audio data based on a command from the second controller 250.

According to embodiments of the present disclosure, no matter how many audio songs a storage medium has, random play speed for the audio songs may increase when power is restored, power is changing, or the storage medium is reloaded. Even in a random play mode of audio songs, previous or next songs may be played at the request of a user. In other words, even if the user issues a command to play a previous song, a song previous to the currently played song may be played intact, thereby increasing the user's satisfaction.

Furthermore, according to the embodiments of the present disclosure, audio songs may be randomly played using the least amount of memory. In addition, reliability of an audio playing device may be improved by preventing instantaneous overload that might occur when a random list has to be re-created after all the audio songs in the random list were played. This may lead to improvement of the quality and salability of a terminal or vehicle having an audio play function, which in turn increases the user's satisfaction and convenience of use.

Several embodiments have been described, but a person of ordinary skill in the art will understand and appreciate that various modifications can be made without departing the scope of the present disclosure. Thus, it will be apparent to those ordinary skilled in the art that the disclosure is not limited to the embodiments.

What is claimed is:

1. A vehicle comprising:
a communication unit enabling communication with an external device;
a storage storing a plurality of song information of audio songs stored in the external device;
an input unit receiving a play command from the external device;
a controller controlling the storage so as to store the plurality of song information and reading out audio data from the external device based on the plurality of song information stored in the storage, upon reception of the play command from the external device; and
a sound output unit outputting the audio data read out by the controller,
wherein, when the play command is received from the external device, the controller controls the storage so as to store a predetermined number of song information among the plurality of song information in a first database of the storage and store the remaining song information of the plurality of song information in a second database of the storage, determines rankings of the song information stored in the first database, and controls the sound output unit so as to output the audio songs sequentially based on a reference ranking.

2. The vehicle of claim 1,
wherein, when the received play command corresponds to a command to perform random play, the controller controls the storage so as to randomly store the predetermined number of song information among the plurality of song information in the first database and randomly store the remaining song information in the second database, deletes a predefined number of top ranking song information from the first database, and adds a predefined number of song information stored in the second database to a lowest ranking in the first database.

3. The vehicle of claim 2,
wherein the reference ranking corresponds to any of the rankings of the song information stored in the first database excluding the highest and the lowest rankings thereof.

4. The vehicle of claim 2,
wherein the reference ranking corresponds to a middle ranking of the rankings of the song information stored in the first database.

5. The vehicle of claim 2,
wherein the controller determines song information in a ranking to be played and reads out audio data corresponding to the determined song information from the storage, while playing control is performed.

6. The vehicle of claim 2,
wherein, when the received play command corresponds to a command to perform sequential play, the controller arranges the song information stored in the first database in a predetermined order corresponding to an order in which the audio songs are stored in the external device.

7. The vehicle of claim 2,
wherein, when a command to play a previous song is received from the external device, the controller updates top ranking song information stored in the first database and deletes lowest ranking song information from the first database.

8. The vehicle of claim 2,
wherein the controller deletes top ranking song information from the first database and adds song information stored in the second database to the lowest ranking in the first database.

9. The vehicle of claim 2,
wherein the second database stores a plurality of song information and rankings that match the plurality of song information, and
wherein the controller sequentially extracts the plurality of song information stored in the second database and adds song information deleted from the first database to the extracted ranking, when adding song information to the lowest ranking in the first database.

10. The vehicle of claim 1,
wherein the second database stores a plurality of song information and rankings that match the plurality of song information, and
wherein the controller randomly extracts song information stored in the second database and adds song information deleted from the first database to the extracted ranking, when adding song information to the lowest ranking in the first database.

11. A vehicle comprising:
a communication unit enabling communication with an external device;
a storage storing a plurality of song information of audio songs stored in the external device;
a controller controlling the storage so as to randomly store a predetermined number of song information among the plurality of the song information in a first database of the storage and randomly store the remaining song information of the plurality of song information in a second database of the storage, and reading out audio data from the storage based on the song information stored in the first database, when a command to perform random play is received from the external device; and
a sound output unit outputting the audio data read out by the controller,
wherein, when an audio song different from a currently played audio song is to be played, the controller deletes a predefined number of song information from the first database and adds a predefined number of song information in the second database to the first database.

12. The vehicle of claim 11,
wherein the first database stores a list of a plurality of song information with matching rankings,
wherein the controller determines song information having higher rankings than song information of the currently played audio song, and
wherein, when deleting the predefined number of song information from the first database, the controller selects and deletes a predetermined number of song information in correspondence with a predetermined number of rankings from currently played song information among the higher ranking song information.

13. The vehicle of claim 11, wherein, when adding the song information in the second database to the first database, the controller additionally creates a predetermined number of rankings for lowest rankings in the first database and adds a predetermined number of song information stored in the second database to the predetermined number of created lowest rankings.

14. A terminal detachably equipped with an external device, the terminal comprising:
a storage storing a plurality of song information;
an input unit receiving a play command;
a controller controlling the storage so as to randomly store a predetermined number of song information among the plurality of song information in a first database of the storage and randomly store the remaining song information of the plurality of song information in a second database of the storage, and reading out audio data from the storage based on the song information stored in the first database, when a command to perform random play is received at the input unit; and
a sound output unit outputting the audio data read out by the controller,
wherein, when a command to play an audio song different from a currently played audio song is received, the controller deletes song information from the first database and adds song information in the second database to the first database.

15. The terminal of claim 14,
wherein the first database stores a list of a plurality of song information with matching rankings,
wherein the controller determines song information having higher rankings than song information of the currently played audio song, and
wherein, when deleting the song information from the first database, the controller selects and deletes a predetermined number of song information in correspondence with a predetermined number of rankings from currently played song information among the higher ranking song information.

16. The terminal of claim 14,
wherein the first database stores a list of a plurality of song information with matching rankings, and
wherein, when adding song information in the second database to the first database, the controller additionally creates a lowest ranking in the first database and adds a predefined number of song information stored in the second database to the created lowest ranking.

17. The terminal of claim 14,
wherein the first database stores a list of a plurality of song information with matching rankings, and
wherein, in a random play mode, the controller determines song information according to a reference ranking among the song information in the first database and controls the sound output unit so as to output an audio song for the first time that corresponds to the determined song information according to the reference ranking.

18. The terminal of claim 14,
wherein the first database stores a list of a plurality of song information with matching rankings,
wherein the controller updates top ranking song information stored in the first database and deletes lowest ranking song information from the first database when a command to play a previous song is received, and
wherein the controller deletes top ranking song information from the first database and adds a predetermined number of song information stored in the second database to the lowest ranking in the first database when a command to play a next song is received.

19. The terminal of claim 14,
wherein the first database stores a list of a plurality of song information with matching rankings,
wherein the second database stores a plurality of song information and rankings that match the plurality of song information, and
wherein, when adding song information to the lowest ranking in the first database, the controller randomly extracts the plurality of song information stored in the second database and adds song information deleted from the first database to the extracted ranking.

20. A method for controlling a vehicle in communication with an external device, the method comprising:
randomly storing, by a controller, a predetermined number of song information among a plurality of song information of audio songs in a first database of a storage, when a command to perform random play is received at an input unit;
randomly storing, by the controller, the remaining song information of the plurality of song information in a second database of the storage;
determining, by the controller, rankings of the song information stored in the first database; and
sequentially playing, by the controller, audio songs according to a reference ranking using a sound output unit,
wherein the sequentially playing of audio songs comprises:
determining song information in a ranking to be played, reading out audio data from the storage based on the determined song information, and, when the playing of an audio song is completed, deleting top ranking song information from the first database and adding song information stored in the second database to a lowest ranking in the first database.

21. The method of claim 20, wherein the reference ranking corresponds to any of the rankings of the song information stored in the first database excluding the highest and the lowest rankings thereof.

22. The method of claim 20, further comprising:
updating, by the controller, the top ranking song information in the first database when a command to play a previous song is received; and
deleting, by the controller, lowest ranking song information in the first database.

23. The method of claim 20, further comprising:
deleting, by the controller, the top ranking song information in the first database when a command to play a next song is received; and
adding song information stored in the second database to the lowest ranking in the first database.

24. The method of claim 20,
wherein the second database stores a plurality of song information and rankings that match the plurality of song information, and
wherein the adding of song information to the lowest ranking in the first database comprises:
sequentially extracting the song information stored in the second database and adding song information deleted from the first database to the extracted ranking.

25. The method of claim 20,
wherein the second database stores a plurality of song information and rankings that match the plurality of song information, and
wherein the adding of song information to the lowest ranking in the first database comprises:
randomly extracting song information stored in the second database and adding song information deleted from the first database to the extracted ranking.
